(19) United States
(12) Patent Application Publication
(10) Pub. No.: US 2026/0225570 A1
(43) Pub. Date: Aug. 6, 2026

(54) BRAKING SYSTEM FOR A MOTOR VEHICLE, BRAKING DEVICE FOR A MOTOR VEHICLE, AND METHOD FOR CONTROLLING A BRAKING SYSTEM OF A MOTOR VEHICLE

(71) Applicants: thyssenkrupp Presta AG, Eschen (LI); thyssenkrupp AG, Essen (DE)

(72) Inventors: Barna SZIMANDL, Gams (CH); Mark MULLER, Budapest (HU); Zoltan Szabolcs ERDELYI, Budapest (HU)

(73) Assignees: thyssenkrupp Presta AG, Eschen (LI); thyssenkrupp AG, Essen (DE)

(21) Appl. No.: 19/154,734

(22) PCT Filed: Oct. 24, 2023
(86) PCT No.: PCT/EP2023/079621

§ 371 Date: Aug. 7, 2025

(30) Foreign Application Priority Data
Feb. 13, 2023 (BE) BE 2023/5101

(51) Int. Cl. B60T 13/74; B60T 17/22; F16D 65/18; F16D 121/24

(52) U.S. Cl. CPC B60T 13/746; B60T 17/22; F16D 65/18; B60T 2220/04; B60T 2240/00; B60T 2270/402; F16D 2121/24

(57) ABSTRACT

A braking system for a motor vehicle comprises at least two braking devices each with a brake actuator, wherein each of the brake actuators has an electric actuating motor, and wherein the braking devices are connected to a central control unit which is designed for connecting to at least one input device. In order to reduce the complexity in terms of production and assembly and to increase safety, at least two wheel brake control units are provided, which are each connected to a brake actuator, and which are connected to the central control unit.

### PRIOR ART

The invention relates to a braking system for a motor vehicle, comprising at least two braking devices each having a brake actuator, wherein each of the brake actuators has an electric actuating motor, and wherein the braking devices are connected to a central control unit which is designed for connecting to at least one input device, is provided according to the invention. A braking device for use in a braking system of this type, and a method for controlling a braking system, are likewise the subject matter of the invention.

A braking system of this type comprises at least two electric-motor braking devices which are in each case assigned to a wheel of a motor vehicle to be braked. This is therefore also referred to as a brake unit or wheel brake. An electric-motor braking device has an electric-motor brake actuator which is supported on the chassis relative to the rotation of the wheel to be braked, and which has at least one electric actuating motor. The latter acts by way of an actuating device on a brake part, for example a brake pad, which by being rotationally driven by the actuating motor can be brought into braking engagement with a counter-brake part attached to the wheel to be braked, for example a brake disk. During the braking engagement, friction contact is produced between the brake part and the counter-brake part, with the braking torque produced by friction being greater, the higher the adjustment force is which is exerted by the actuating device in the adjustment direction. In the prior art, such braking systems are known, for example, from DE 10 2017 123 266 A1 or U.S. Pat. No. 6,081,081 A.

The braking system is controlled electrically. An electric brake command for initiating a braking operation can be generated manually by an input device such as a brake pedal or a parking brake switch, and additionally or alternatively by an automated input device such as an anti-lock braking system (ABS) or an automatic drive system (ADS). This allows the actuating motors of the brake actuators to be actuated and braking devices to be brought into braking engagement. The optimum braking torque, by means of which the shortest possible braking distance can be implemented ideally without blocking the wheels, can be determined from the target values provided with the brake command and other relevant actual parameters for the braking process, such as wheel position, wheel speed, electric current of the actuating motor, braking force, vehicle speed and the like. In the aforementioned prior art, it is known to feed at least the values for the brake command and, if necessary, further values into a central control unit, which can be synonymously referred to as ECU (electronic control unit). This control unit uses a predefined control algorithm to determine the control currents emitted to the actuating motors of all brake actuators, which are required to generate defined wheel braking torques.

In the aforementioned U.S. Pat. No. 6,081,081 A, each brake actuator can be controlled individually by the central control unit. In principle, this makes it possible to activate each braking device separately to optimize braking performance. However, taking into account the fact that in addition to the electrical control lines routed from the ECU to the individual braking devices, additional feedback or control lines must be provided from the braking devices back to the ECU, there is a relatively large amount of wiring involved. This makes production and assembly difficult. In addition, due to the relatively large required cable lengths of the control cables, electrical interference can occur, for example also due to the high electrical currents in electric vehicles. This may require additional safety measures, which in turn means an increased complexity.

In view of the set of issues described above, it is an object of the present invention to reduce the complexity in terms of production and assembly, and to increase safety.

### SUMMARY OF THE INVENTION

This object is achieved according to the invention by the braking system having the features of claim 1, by the braking device as claimed in claim 8, and by the method for controlling a braking system of a motor vehicle as claimed in claim 11. Advantageous refinements are derived from the dependent claims.

In a braking system for a motor vehicle comprising at least two braking devices each having a brake actuator, wherein each of the brake actuators has an electric actuating motor, and wherein the braking devices are connected to a central control unit which is designed for connecting to at least one input device, it is provided according to the invention that at least two wheel brake control units are provided, which are each connected to a brake actuator, and which are connected to the central control unit.

One braking device, which can simultaneously also be referred to as a brake unit or wheel brake, is in each case assigned to one wheel of the vehicle. Each braking device has a brake actuator with at least one electric actuating motor which by way of an actuating device can exert an adjustment force on a brake part, for example a brake pad. This allows the brake part to be brought into braking engagement with a counter-brake part associated with the wheel, for example a brake disk.

The braking devices can be activated by input devices which may have manual input devices such as a brake pedal or a parking brake switch, and additionally or alternatively automated input devices such as an anti-lock braking system (ABS) or an automatic drive system (ADS). The input devices are electrically connected to the central control unit.

According to the invention, the braking system has at least two wheel brake control units separate from the central control unit (ECU). These are electrically actuatable by the central control unit using control signals. Owing to the fact that at least two wheel brake control units are provided, which are in each case assigned to a braking device and connected to a brake actuator, it is in other words provided that at least two braking devices each have a dedicated wheel brake control unit which is connected to the central control unit and to the brake actuator.

Each wheel brake control unit can be actuated by the ECU with target braking values generated from a brake command received from the input devices. Due the combination of the central control unit with at least two decentralized wheel brake control units associated with the wheels according to the invention, decentralized controlling of the brakes is implemented. This makes a simpler and shorter wiring possible, for example, from a wheel sensor, for example, a wheel position sensor, which is assigned to a wheel and can be connected directly to the wheel brake control unit of the braking device likewise assigned to the wheel. As a result, the complexity in terms of production and assembly can advantageously be reduced. Moreover, the sensitivity to external interference can be reduced. Due to the decentralized design of the brake control according to the invention, a higher redundancy can furthermore be implemented, so that the operational safety can be increased.

A wheel brake control unit can preferably be of a design integrated with the braking device. This enables a compact, safe and easy-to-install construction to be implemented.

Preferably, each of the braking devices has a wheel brake control unit, for example, in a 4-wheeler vehicle with four braking devices a corresponding number of four wheel brake control units can be provided, or in a 2-wheeler vehicle with two braking devices a corresponding number of two wheel brake control units can be provided.

It is preferred that a wheel brake control unit is in each case connected to at least one brake actuator. A wheel brake control unit provides the actuation of the brake actuator or actuators with a defined target control signal in order to generate a defined braking torque for the wheel assigned to the respective braking device.

It is possible that each of the wheel brake control units is connected to an electric actuating motor. The wheel brake control unit can control the actuating motor using electrical target control values of the control current. Two or more actuating motors of a braking device can also be connected to a wheel brake control unit.

Preferably, it can be provided that each wheel brake control unit is connected to a sensor device. The sensor device can preferably comprise a wheel sensor assigned to the respective wheel to be braked. This wheel sensor can be designed to detect relevant parameters (actual values) for a braking operation, such as wheel position, wheel speed, vehicle speed, slip and the like, and to transmit them to the wheel brake control unit. Furthermore, a sensor device for detecting the electric current of the actuating motor, the braking force, and the like can be provided. Preferably, each of the braking devices has a sensor device, preferably at least one wheel sensor. An advantage is that the sensor unit, in particular a wheel sensor assigned to the respective brake unit, can be connected with less complexity. Owing to the fact that relevant parameters can be measured on the wheel to be braked and be supplied directly, without any intervention of the central control unit, to the wheel brake control unit, the operational reliability and redundancy can be increased.

It may be provided that each wheel brake control unit has a feedback-control unit.

The electric feedback-control unit compares the actual values of a wheel sensor, or of another sensor device, with the target values of a brake command transmitted by the central control unit to the wheel brake control unit, and actuates the actuating motor or actuating motors of the brake actuator accordingly in order to achieve the target values.

The invention furthermore relates to a braking device for a motor vehicle, which comprises a brake actuator with an electric actuating motor and a wheel sensor, in which it is provided according to the invention that the braking device has a wheel brake control unit which is connectable to the brake actuator and the wheel sensor.

The braking device can preferably be used in a braking system of the type described above, wherein all of the features described in this context can be implemented.

The wheel sensor, also referred to as the wheel position sensor, can be designed as described above.

The wheel brake control unit is designed for connecting to the central control unit and to at least one wheel sensor. The at least one actuating motor of the brake actuator can be electrically actuated by the wheel brake control unit.

The wheel brake control unit can preferably be designed to be integrated with the braking device, for example by structural integration in a housing of the braking device.

In a method for controlling a braking system of a motor vehicle, which comprises at least two braking devices each having a brake actuator, wherein each of the brake actuators has an electric actuating motor, and wherein the braking devices are connected to a central control unit which is designed for connecting to at least one input device, wherein a brake command by way of at least one input device is entered into the central control unit which actuates the brake actuators using control signals, it is provided according to the invention that the central control unit sends control signals to at least two wheel brake control units which are in each case assigned to a braking device and in each case actuate a brake actuator of the respective braking device. For implementing the method according to the invention, all features and procedures which have been described above in the context of the braking system and the braking device can be utilized.

An advantage of the method according to the invention is that improved operational safety can be achieved due to the decentralized control architecture, for example due to the robust design, which is less sensitive to external interference, and the possibility of redundant distribution of control functions to the central control unit and the wheel brake control units according to the invention. For example, an anti-lock braking control (ABS) can be carried out by the wheel brake control unit together with the associated wheel sensor in a decentralized manner and independently of the central control unit. This enables increased operational reliability to be implemented.

It is advantageous that actual signals from a wheel sensor of the respective braking device are transmitted to each of the wheel brake control units. According to a control algorithm, the actuation of the respective brake actuator is feedback-controlled in the respective wheel brake control unit taking into account the actual signals of the wheel sensor, such as wheel position and/or wheel speed, so that the target values specified by the brake command are implemented. The wheel sensor provides the actual signals of the measured parameters preferably in real time.

Actual values provided by further sensor devices can also be taken into account and processed, such as, for example, electric current of the actuating motor, braking force, vehicle speed and the like.

An advantage of the method according to the invention is that the processing of the signals supplied by the wheel sensor (wheel position sensor) can take place practically in real time in the decentralized wheel brake control units of the braking devices. This enables an increased processing speed and operational reliability as well as a redundant design of the control system to be implemented.

An advantageous embodiment of the braking system according to the invention can provide that the braking device comprises an actuating device and a brake part which is connected thereto, is adjustable along an axis by the actuating device and can be brought into braking engagement with a counter-braking part, wherein the actuating device has a first actuating drive and a second actuating drive which is coupled in series thereto, wherein the first actuating drive has a rotationally drivable first drive wheel, and the second actuating drive has a rotationally drivable second drive wheel which is coaxial with the first drive wheel, wherein a clutch device is disposed between the first drive wheel and the second drive wheel.

The actuator is drivable by at least one electric actuating motor. The latter preferably meshes with at least one drive wheel. Preferably, one actuating motor can in each case be provided for the first and the second drive wheel respectively. According to the invention, the actuating motor or motors are actuatable by a wheel brake control unit assigned to the braking device.

In the latter embodiment, it can be provided that the coupling device is configured as a friction clutch having a friction element which during engagement of the clutch is connectable in a friction-fitting manner with a counter-friction element.

In the following text, the first and the second drive wheel together are also referred to as the two drive wheels or as the drive wheels for short.

The drive wheels can each be designed as a gearwheel, for example as a spur gear, or as a belt wheel or timing belt pulley or worm wheel, and therefore generally a transmission wheel by way of which a driving torque from an electric actuating motor can be coupled into the actuating drive is provided.

A friction clutch is implemented between the drive wheels. Said friction clutch comprises a friction element, which is connected torque-lockingly to one of the drive wheels, and a corresponding counter-friction element, which is connected torque-lockingly to the respective other drive wheel. The friction element can be brought into frictional coupling engagement with the counter-friction element in any relative angular position. As opposed to a form-fitting latching connection, a purely force-fitting clutch is implemented here. As a result, the relative position of the drive wheels with respect to one another can be predefined continuously, in contrast to the discrete latching stages of a latching connection. Accordingly, a uniform, continuous adjustment of the second actuating drive relative to the first actuating drive is possible, and the air gap can be continuously adjusted. This is particularly advantageous with regard to uniform tracking of the optimum working point of the braking device to the continuous wear of the brake part during operation, i.e. the continuous wear of the brake pad. Compared to an only gradual adjustment option, a continuously improved response behavior of the braking device, and thus increased operational reliability and greater operating comfort, can be implemented.

Another advantage in comparison to a latching clutch lies in that for actuating and releasing the clutch device, essentially no axial relative movement is required between the clutch elements which are in clutch engagement, for example between the drive wheels or the latching elements, which inevitably have to be movable with relative to one another in order to produce and release the latchable form fit. On the other hand, the pure force fit between the friction element and counter-friction element according to the invention can be simply predetermined by the applied axial actuation force, wherein the friction element and counter-friction element do not have to be moved axially relative to each other. This enables a simpler and more reliable structural design of the clutch device.

It is preferably provided that the friction clutch has a predefinable clutch torque. The clutch torque specifies the maximum differential torque, which can be transmitted with a force fit between the friction element and the counter-friction element by the friction connection during the engagement of the clutch. When the clutch torque is exceeded, the clutch device slips such that the two drive wheels are rotated relative to each other. One advantage is that the friction clutch according to the invention continuously slips, and therefore an improved, uniform readjustment of the air gap is enabled. Moreover, no axial deviating movements of latching elements, as in the case of the known latching clutch, have to be taken into consideration structurally and absorbed.

It is advantageous that the friction element and the counter-friction element are arranged coaxially. The coaxial arrangement corresponds to the coaxial arrangement of the drive wheels. The friction element and the counter-friction element can be disposed in a structurally simple manner and in a compact construction mode in the region of the mutually opposite end faces of the drive wheels. Due to the pure force-fit generated by the clutch, as described above, no movable parts whatsoever are required.

In an advantageous embodiment, it can be provided that the friction element and the counter-friction element are conical. The friction element can have a conical section at least partly converging in the axial adjustment direction and having a conical friction surface, which can be designed as an outer cone or inner cone, and which has a corresponding conical section on the counter-friction element, which is correspondingly designed in the opposite direction as an inner cone or outer cone and has a conical counter-friction surface. To produce the engagement of the clutch, the outer cone enters the inner cone, with the conical friction and counter-friction surfaces being loaded frictionally against each other by an axial actuation force of the clutch. One advantage is that the axially acting actuation force of the clutch can be converted by the cone into the normal force acting between the conical friction surfaces during the friction contact. Thus, a relatively small axial actuation force can be converted by a relatively shallow slope into a larger normal force in the friction contact, as a result of which a high clutch torque can already be realized by a relatively small axial actuation force of the clutch.

Alternatively or in addition to the above-mentioned embodiment, it can be provided that the friction element and the counter-friction element are planar. The mutually corresponding friction surfaces are at least partly designed as flat axial surfaces, similar to a disk clutch. A space-saving arrangement is made possible, especially if only a relatively small clutch torque is to be realized.

It can preferably be provided that the friction element and the counter-friction element are preloaded against each other. Preferably, the friction element and the counter-friction element are preloaded against each other elastically or resiliently. The friction and counter-friction surfaces are pressed against each other in the frictional connection by a predetermined axial preload force. In order to generate the preload force, an elastic preload element can preferably be provided, for example, a spring element or the like. The clutch torque of the friction clutch is determined by the actuation force acting perpendicular to the friction contact, i.e. the force applied axially between the friction and counter-friction element, with a greater preload force resulting in a larger clutch torque. This opens up the advantageous possibility of simply predetermining the clutch torque by the preload force exerted by the preload element. For example, in the case of a spring element which is flexible in the axial direction under pressure, such as a compression spring, the preload force exerted can be simply predetermined and adjusted by the spring constant and the compression of the spring.

The aforementioned embodiment can be advantageously implemented in that the friction element and/or the counter-friction element are/is axially displaceable and supported against the first drive wheel or the second drive wheel via an axially effective spring element. The friction element or the counter-friction element are torque-lockingly and axially displaceably connected to the one drive wheel, for example via radially projecting drivers producing a form fit, which is effective in the circumferential direction. The spring element which is axially clamped between the friction element or the counter-friction element and the one drive wheel and is preferably designed as an axially effective compression spring ensures that the friction or counter-friction element is preloaded axially against the corresponding counter-friction or friction element, which is axially supported on the other drive wheel, i.e., is axially pressed against it during the friction contact. The corresponding counter-friction or friction element is connected to the respective other drive wheel for conjoint rotation. It is also possible that, alternatively or additionally, the counter-friction element is supported on one of the drive wheels via a spring element. One advantage of this arrangement is that this friction clutch can be incorporated between the drive wheels in a structurally simple and space-saving manner.

In an advantageous refinement, it is possible that the friction element and/or the counter-friction element are/is arranged in the first drive wheel or the second drive wheel. For example, it is possible to design the drive wheel to be substantially drum-shaped, and therefore the friction or counter-friction element can be arranged in an interior space enclosed by the rotating gearwheel or gear rim. This permits a compact design which is protected against external influences. Thus, for example, the drive wheel of the first actuating drive can have a conical friction element which engages axially in a counter-friction element, which is designed as an inner cone and is at least partly arranged within the second drive wheel.

A particularly compact design can be realized—in particular in the last-mentioned embodiment—in that the drive wheels are arranged within the axial extent of the actuating drives, i.e., are not attached protruding axially on one side.

It is preferred that the friction element and/or the counter-friction element have/has a friction pad. The friction and counter-friction element preferably have a metallic basic body, for example made of steel. In order to avoid metal-to-metal contact, a coating or a pad for producing a friction pairing with a defined friction force can preferably be applied, for example, made of sintered materials, metal and/or ceramic friction materials, composite materials or the like. This can ensure a defined, reproducible clutch torque.

It can be provided that an actuating drive has a spindle drive. In this case, in a manner known per se, a threaded spindle engages in a spindle nut and a relative rotating drive via a drive wheel connected to the threaded spindle or the spindle nut. It is possible for the spindle nut to form the drive-side drive element of the actuating drive, and the threaded spindle the output-side output element, which is linearly adjustable relative thereto, or vice versa.

It is possible for an actuating drive to have a wedging disk arrangement, ball ramp arrangement or a tilting pin arrangement. In the case of a ball ramp arrangement, also referred to as ramp bearings, the drive and output elements preferably have cam disks with raceways or ramps which are inclined against the axis and between which balls which are rollable in the circumferential direction are arranged. Owing to the balls rolling on the ramps, a relative rotation causes the output element to be axially displaced relative to the drive element. In a tilting pin arrangement which is known per se, tilting pins are arranged between the drive element and output element and are each supported in the circumferential direction in such a way that, in the event of a relative rotation, they are inclined to a greater or lesser extent against the axis depending on the direction of rotation, as a result of which the distance between the drive element and output element is also adjustable.

In the actuating device, two identically acting actuating drives can be combined with each other as first and second actuating drives, for example, two spindle drives. It is also possible to com-bine two different designs together, for example, a ball ramp arrangement as the first actuating drive, and a spindle drive as the second actuating drive, for adjusting the air gap. The respective characteristic properties of each design can be optimally exploited. For example, a non-linear adjustment characteristic and/or at least partially self-locking properties, and/or a defined dead center or extended position, which permits a defined adjustment path, can be realized with little outlay using a ball ramp arrangement. The implementation of the aforementioned positive properties may at least partially require a precise specification of the air gap, which can be implemented without any problems using the friction clutch according to the invention.

A braking device according to the invention can comprise an actuating device and brake part which is connected thereto, is adjustable along an axis by the actuating device and can be brought into braking engagement with a counter-braking part, wherein the actuating device has a first actuating drive and a second actuating drive which is coupled in series thereto, wherein the first actuating drive has a rotationally drivable first drive wheel and the second actuating drive has a rotationally drivable second drive wheel which is coaxial with the first drive wheel, wherein a clutch device is disposed between the first drive wheel and the second drive wheel.

The actuator is drivable by at least one electric actuating motor. The latter preferably meshes with at least one drive wheel. Preferably, one actuating motor can in each case be provided for the first and the second drive wheel respectively. According to the invention, the actuating motor or motors are actuatable by a wheel brake control unit assigned to the braking device.

In the latter embodiment of the braking device it may preferably be provided that the clutch device is configured as a friction clutch having a friction element which during engagement of the clutch is connectable in a friction-fitting manner with a counter-friction element.

This makes it possible to implement the advantages explained above in the context of the braking system.

In order to implement the method according to the invention, it can be provided that the braking device has an actuating device which is able to be coupled to an actuating motor and comprises a first actuating drive and a second actuating drive coupled in series thereto, and which acts on a brake part that in the direction of an axis can be brought into braking engagement with a counter-braking part, wherein the first actuating drive has a rotationally drivable first drive wheel to which a first drive torque can be applied for activation, and the second actuating drive has a rotationally drivable second drive wheel which is coaxial with the first drive wheel and to which a second drive torque can be applied for activation, wherein a clutch device is disposed between the first drive wheel and the second drive wheel, wherein it is provided according to the invention that the clutch device is configured as a friction clutch and has a predefinable clutch torque which when exceeded causes the first drive wheel to slip relative to the second drive wheel, wherein, for activation of the first actuating drive, the first drive wheel and the second drive wheel are driven synchronously so that the second actuating drive remains non-activated, and for activation of the second actuating drive, the second drive wheel is driven and the first drive wheel is stopped relative thereto, so that the friction clutch slips and the first actuating drive remains non-activated.

The features mentioned above in conjunction with the braking device according to the invention can be used individually and in combinations for implementing the method according to the invention.

For adjusting the first actuating drive, an actuating torque can be coupled into the first drive wheel by means of a first electric actuating motor and, accordingly, the second actuating drive can be driven by a second electric actuating motor.

During the normal braking mode, the first and second drive wheels are rotated synchronously. This can take place, on the one hand, by the first and second drive wheels being driven by the first and second actuating motors with synchronized driving torques. On the other hand, the second drive wheel can be entrained synchronously by the clutch device during driving of the first drive wheel, as long as the transmitted driving torque remains under the clutch torque. In this operating mode, the second actuating drive remains non-activated and idly revolves as a whole together with the brake element.

In the method, when the clutch torque is exceeded, in order to adjust the air gap, the clutch device can slip continuously and uniformly. This can be implemented, for example, in that the drive wheel of the first actuating drive is stopped, for example by a brake or a corresponding activation of the first drive motor, while a second driving torque, which is greater than the clutch torque, is applied to the second drive wheel by the second drive motor. Thus, the second drive wheel is rotated relative to the first drive wheel and, by activating the second actuating drive, the air gap can be continuously and finely adjusted such that continually progressive wear on the brake element or the brake pad can be optimally compensated.

It is possible for the first drive wheel and the second drive wheel to be coupled in a torque-fitting manner by the friction clutch in order to produce a synchronous drive.

In this case, synchronous driving of the two drive wheels by the actuating motors is not required. Any torque differences can be compensated within predetermined tolerances.

It can be advantageously provided that a higher clutch torque is specified when the first actuating drive is actuated than when the second actuating drive is actuated. The first actuating drive is actuated by synchronous driving of the first and second drive wheels. The friction element and the counter-friction element are preloaded against each other by the spring force of the spring element, and in addition, the adjustment force of the first actuating drive acts in opposition to the spring force. This results in a relatively high clutch torque. If, on the other hand, only the second drive wheel is rotated to adjust the air gap, the spring force alone is in action, and therefore a lower clutch torque is set. This facilitates the adjustment of the air gap.

### DESCRIPTION OF THE DRAWINGS

Advantageous embodiments of the invention will be described in more detail hereunder with reference to the drawings, In the figures:

FIG. 1 schematically shows a braking system of a motor vehicle according to the invention in a schematic stand-alone illustration;

FIG. 2 shows a design diagram of a braking system according to the invention;

FIG. 3 shows a schematic perspective view of a braking device according to the invention;

FIG. 4 shows a lateral view of the braking device according to FIG. 3;

FIG. 5 shows a section Q-Q through the braking device according to FIG. 3;

FIG. 6 shows a stand-alone schematic perspective illustration of the first actuating drive of the braking device according to FIG. 1 and

FIG. 7 shows an enlarged detailed view of the actuating device from FIG. 5.

### EMBODIMENTS OF THE INVENTION

In the various figures, identical parts are always provided with the same reference signs, and will therefore generally also be named or mentioned only once in each case.

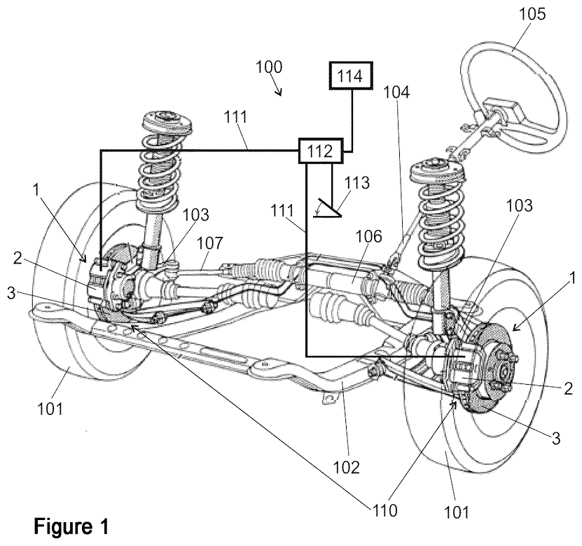

FIG. 1 shows a schematic perspective partial stand-alone illustration of a chassis 100 of a motor vehicle. This comprises steerable wheels (vehicle wheels) 101 which are mounted on pivotable steering knuckles 103 on a frame part of the body 102 of the motor vehicle.

A steering system comprises a steering shaft 104 on the rear end of which, in the direction of travel, a steering wheel 105 is disposed as a manual steering input. The steering shaft 104 is connected to a steering gear 106 which by way of tie rods 107 is connected to the steering knuckles 103 in order to generate a steering angle.

A braking system 110 has one braking device 1 for each of the two wheels (vehicle wheels) 101. This braking device 1 has in each case one brake caliper 2 which is attached to the motor vehicle body 102 and supported thereon. A brake disk 3, which is encompassed by the brake caliper 2 stationary relative to the latter, is in each case co-rotationally attached to a wheel 101. The braking devices 1 are connected to a central control unit 112 (ECU) via electrical control lines 111. A schematically illustrated brake pedal 113 mounted on the body 102, which is a manual input device, is likewise connected to the ECU 112.

Furthermore, an automated input device 114, which can send external control signals for controlling the braking system 110 to the ECU 112, can be connected to the ECU 112.

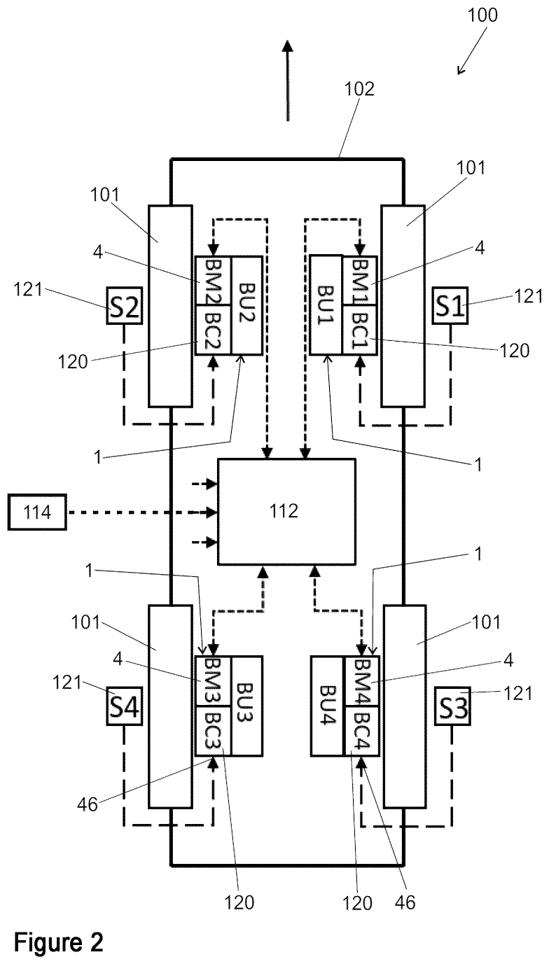

Illustrated in FIG. 2 is a schematic diagram of the chassis 100 with a braking system 110. The vehicle has four wheels 101, each of which is assigned a braking device 1 according to the invention.

Each of the braking devices 1 (BU1, BU2, BU3, BU4) has in each case a brake actuator 4 (BM1, BM2, BM3, BM4) and a wheel brake control unit 120 (BC1, BC2, BC3, BC4) according to the invention. A wheel sensor 121 (S1, S2, S3, S4), which is preferably configured as a wheel position sensor and transmits real-time actual values of the rotational position to the wheel brake control unit 120 during travel, is in each case connected to the wheel brake control unit 120.

The wheel brake control unit 120 is preferably configured to be integrated with the braking device 1 and electrically connected to the brake actuator 4, the latter having in each case electric actuating motors 41, 42 which are explained in more detail below.

Each total of four braking devices 1 in the example shown has a dedicated wheel brake control unit 120, which can exchange electrical control signals with the wheel sensor 121 and the ECU 112, and can drive the brake actuator 4 as a function of said signals. In the process, the actuating motors 41, 42 can be energized by the respective wheel brake control unit 120 for generating a predetermined braking effect.

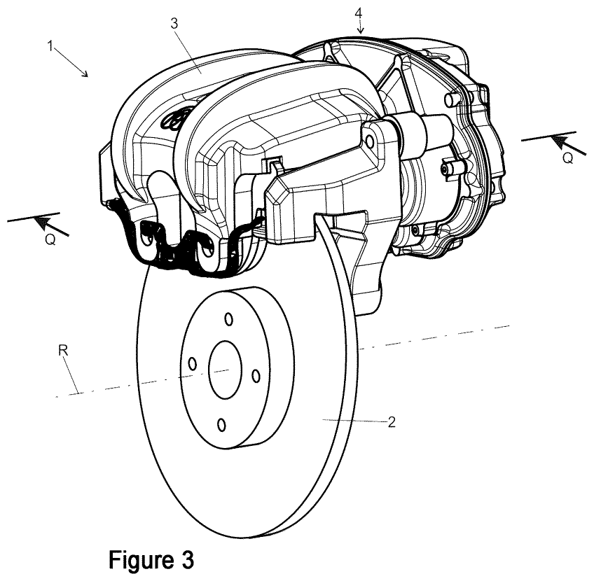

An embodiment of the brake actuator 4 is shown in detail in FIGS. 3, 4 and 5 below. This brake actuator 4 has a housing 45 in which the wheel brake control unit 120 is disposed as can be seen in FIG. 5. This wheel brake control unit 120 has an electrical circuit which is connected to the actuating motors 41, 42 and the ECU 112. As a result, the wheel brake control unit 120 is designed to be integrated with the braking device 1.

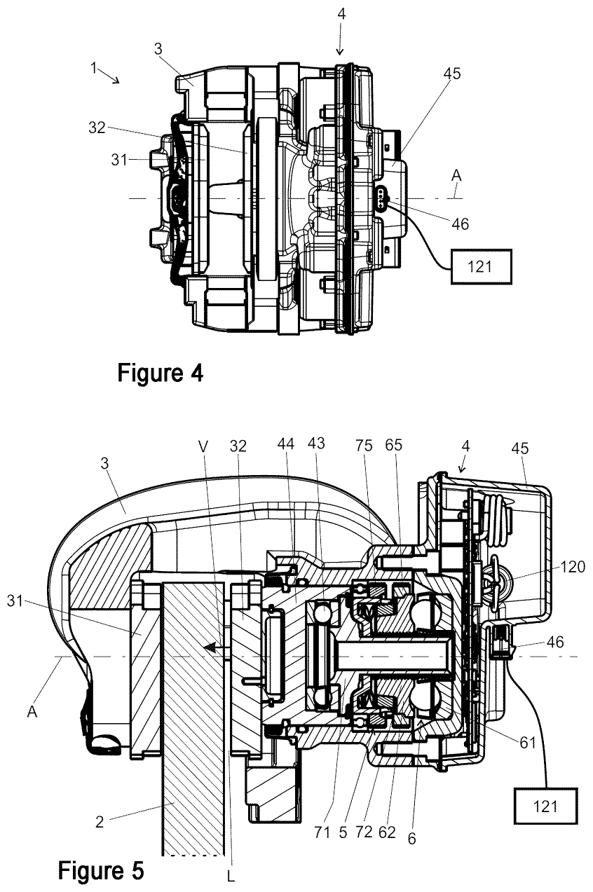

For connecting the wheel sensor 121, which is schematically indicated in FIGS. 4 and 5, the brake actuator 4 has a connection device 46, for example, an electrical plug connector disposed on the housing 45, or the like.

FIG. 3 shows an exemplary embodiment of the braking device 1 according to the invention as a whole, being configured as a disk brake. This braking device 1 comprises a brake disk 2, which forms a counter-brake part and is connected to a vehicle wheel 101 that is rotatable about a wheel axis R and is not illustrated here. A brake caliper 3 engages about the two axial end faces of the brake disk 2.

The brake disk 2 is designed here as an unventilated brake disk made of solid material. Alternatively, it can also be designed as an internally ventilated brake disk.

An electric brake actuator 4 according to the invention is attached to the brake caliper 3.

The brake actuator 4 comprises an actuating device 5 which extends axially in the direction of an axis A that lies parallel to the wheel axis R and indicates the adjustment direction V of the actuating device 5.

FIG. 4 shows a view of the brake caliper 3 as seen from the brake disk 2.

As can be seen in the sectional illustration of FIG. 5 along the axis A, the brake disk 2 is arranged axially between two brake pads 31 and 32. The one brake pad 31 is fixedly supported on the brake caliper 3 on the side facing away from the brake actuator 4. The other brake pad 32, which forms a brake part within the meaning of the invention, is attached to the actuating device 5 and is adjustable by the latter in the axial adjustment direction V, indicated by the axis A, toward the brake disk 2 to produce the braking engagement, as indicated in FIG. 5 by the arrow.

In the unactuated state of the braking device 1, an axial air gap L, which is shown schematically with an exaggerated width in FIG. 4, is located between the brake disk 2 and the adjustable brake pad 32.

The construction of the actuating device 5 is illustrated in FIG. 5 and in the enlarged detail thereof in FIG. 7.

The actuating drive 5 comprises a first actuating drive 6, which has a ramp bearing, and a second actuating drive 7, which is coupled axially thereto in series (with respect to the axis A) and has a spindle drive.

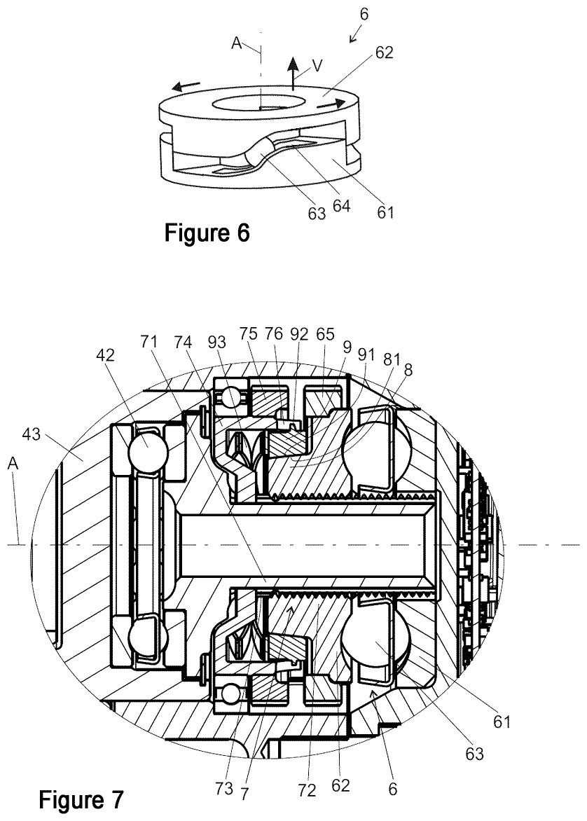

The first actuating drive 6, which is formed in the example shown as a ramp bearing, comprises a drive-side cam disk 61, which is supported axially on the brake actuator 4 for rotation therewith, and an output-side cam disk 62. Balls 63 are arranged between the cam disks 61 and 62. As can be seen in the schematically detached view of FIG. 6, the cam disks 61 and 62 have mutually axially opposite ramp-like raceways 64, which lie obliquely with respect to the axis A and between which balls 63 can roll. Rotation of the output-side cam disk 62, in FIG. 6 above, relative to the fixed drive-side cam disk 61—as schematically indicated by the curved arrows leads to a linear adjustment of the output-side cam disk 62 in the adjustment direction V parallel to the axis A. Thus, as shown in FIG. 4, the brake pad 32 can be brought into braking engagement by activating the first actuating drive 6.

The cam disk 62 is connected to a coaxial gearwheel 65, which is in the form of a spur gear and forms a drive wheel in the context of the invention.

The gearwheel 65 is in transmission engagement with a first electric actuating motor 41. This enables the rotating drive of the cam disk 62 and thus actuation of the first actuating drive 6.

The second actuating drive 7, which in the example shown is in the form of a spindle drive, has, on the output side, a threaded spindle 71, which engages in the internal thread of a drive-side spindle nut 72. This internal thread is formed in the output-side cam disk 62 of the first actuating drive 6 such that the functions of the output-side cam disk 62 and the drive-side spindle nut 72 are combined in one component.

The threaded spindle 71 is connected via a hub part 74 to a coaxial gearwheel 75, which is ro-tatably mounted in axially fixed form in the brake actuator 4. The threaded spindle is torque-lockingly but axially displaceably coupled to the gearwheel 75 via drivers 73, which can have, for example, radially projecting protrusions or teeth, which engage axially movably in axial slots of the hub part 74.

The gearwheel 75, like the gearwheel 65, can be designed as a spur gear and is arranged coaxially adjacent to the latter. This gearwheel 75 is in transmission engagement with a second electric actuating motor 42. This enables the rotating drive of the threaded spindle 71 and thus actuation of the second actuating drive 7.

The threaded spindle 71 is axially connected via a thrust bearing 43, for example, as shown, an axial rolling bearing, to a thrust member 44 to which the displaceable brake pad 32 is attached, as can be seen in FIG. 4. The thrust member 44 may also be referred to as a piston.

The clutch device according to the invention has a friction element 8, which as a coaxial, conical shoulder, is directed from the cam disk 62 to the second actuating drive 7. The conical shoulder has a conical friction surface 81 disposed on the outside of an outer cone. The friction element 81 can preferably be formed integrally with the cam disk 62/spindle nut 72.

When the clutch is engaged, the friction element 8 is frictionally coupled to a counter-friction element 9. In this case, the conical shoulder axially enters a corresponding conical opening in the counter-friction element 9, which has a conical friction surface 91 arranged in an inner cone.

When the clutch is engaged, the friction surface 81 and the counter-friction surface 91 lie frictionally against each other, as can be clearly seen in FIG. 7.

The counter-friction element 9 is torque-lockingly but axially displaceably coupled to the gearwheel 75 via drivers 92, which engage in corresponding slots 76 in the hub part 74 or in the gearwheel 75.

A spring element 93 is disposed between the gearwheel 75, or the hub part 74, connected thereto, and the counter-friction element 9. Owing to its axially effective spring force, the counter-friction element 9 is elastically clamped against the friction element 8. A defined clutch torque of the friction clutch according to the invention formed by the friction element 8 and the counter-friction element 9 is produced as a result.

For actuation of the braking device 1, the gearwheels 65 and 75 are rotated synchronously such that the first actuating drive 6 performs a working stroke in the adjustment direction V, and therefore the brake pad 32 passes through the air gap L and comes into braking engagement with the brake disk 2. The synchronous driving of the gearwheels 65 and 75 can be achieved by synchronizing the drive speeds of the actuating motors 41 and 42, or by the drive being effected by only one of the actuating motors 41 or 42, while the respective other actuating motor 42 or 41 revolves idly. The frictional engagement of the clutch between the friction element 8 and the counter-friction element 9 then ensures synchronous rotation of the gearwheels 65 and 75.

To adjust the width of the air gap L, the gearwheel 65 is fixed or blocked, for example by corresponding activation of the first actuating motor 41. By means of the second actuating motor 42, the gearwheel 75 is rotated relative to the gearwheel 65, with the friction clutch continuously slidingly slipping. Accordingly, the second actuating drive 7 is uniformly adjusted, as a result of which the width of the air gap L can likewise be continuously set and adjusted, for example, to compensate for wear of the brake pad 32.

Owing to the fact that the friction element 8 and the counter-friction element 9 are arranged entirely or at least partially within the gearwheels 65 and 75, a particularly compact design can be realized.

The braking devices illustrated in FIGS. 3 to 7 are in the form of floating caliper brakes, also referred to as fist-type caliper brakes. In this case, the brake pad 32 is pressed by the thrust member 44, and the brake pad 31 by the brake caliper 3, which is movable in the direction of the axis A in relation to the brake disk 2, against the brake disk 2. Alternatively, the solution according to the invention can also be used for a fixed caliper brake.

### LIST OF REFERENCE SIGNS

1 Braking device (BU1, BU2, BU3, BU4)
100 Chassis
101 Wheel (vehicle wheel)
102 Body
103 Steering knuckle
104 Steering shaft
105 Steering wheel
106 Steering gear
107 Tie rod
110 Braking system
111 Control line
112 Central control unit (ECU)
113 Brake pedal
114 Input device
120 Wheel brake control unit (BC1, BC2, BC3, BC4)
121 Wheel sensor
2 Brake disk
3 Brake caliper
31, 32 Brake pad
4 Brake actuator (BM1, BM2, BM3, BM4)
41, 42 Actuating motor
43 Thrust bearing
44 Thrust member
45 Housing
46 Connection device
5 Actuating device
6 First actuating drive
61 Cam disk
62 Cam disk (integrated with spindle nut 72)
63 Ball
64 Raceway
65 Gearwheel
7 Second actuating drive
71 Threaded spindle
72 Spindle nut (integrated with cam disk 62)
73 Driver
74 Hub part
75 Gearwheel
76 Slot
8 Friction element
81 Friction surface
9 Counter-friction element
91 Counter-friction surface
92 Driver
93 Spring element
A Axis
R Wheel axis
V Adjustment direction
L Air gap

1-14. (canceled)

15. A braking system for a motor vehicle, comprising:
at least two braking devices each with a brake actuator;
wherein each of the brake actuators has an electric actuating motor, and wherein the braking devices are connected to a central control unit which is designed for connecting to at least one input device;
wherein at least two wheel brake control units are provided, which are each connected to a brake actuator, and which are connected to the central control unit.

16. The braking system as claimed in claim 15, wherein a wheel brake control unit is in each case connected to at least one brake actuator.

17. The braking system as claimed in claim 15, wherein each of the wheel brake control units is connected to an electric actuating motor.

18. The braking system as claimed in claim 15, wherein each wheel brake control unit is connected to a sensor device.

19. The braking system as claimed in claim 15, wherein each wheel brake control unit has a feedback-control unit.

20. The braking system as claimed in claim 15, wherein the braking device comprises an actuating device and a brake part which is connected thereto, is adjustable along an axis by the actuating device and can be brought into braking engagement with a counter-braking part, wherein the actuating device has a first actuating drive and a second actuating drive which is coupled in series thereto, wherein the first actuating drive has a rotationally drivable first drive wheel and the second actuating drive has a rotationally drivable second drive wheel which is coaxial with the first drive wheel, wherein a clutch device is disposed between the first drive wheel and the second drive wheel.

21. The braking system as claimed in claim 20, wherein the clutch device is configured as a friction clutch having a friction element which during engagement of the clutch is connectable in a friction-fitting manner with a counter-friction element.

22. A braking device for a motor vehicle, comprising:
a brake actuator with an electric actuating motor and a wheel sensor;
wherein the braking device has a wheel brake control unit which is connectable to the brake actuator and the wheel sensor.

23. The braking device as claimed in claim 22, wherein said braking device comprises an actuating device and a brake part which is connected thereto, is adjustable along an axis by the actuating device and can be brought into braking engagement with a counter-braking part, wherein the actuating device has a first actuating drive and a second actuating drive which is coupled in series thereto, wherein the first actuating drive has a rotationally drivable first drive wheel and the second actuating drive has a rotationally drivable second drive wheel which is coaxial with the first drive wheel, wherein a clutch device is disposed between the first drive wheel and the second drive wheel.

24. The braking device as claimed in claim 23, wherein the clutch device is configured as a friction clutch having a friction element which during engagement of the clutch is connectable in a friction-fitting manner with a counter-friction element.

25. A method for controlling a braking system of a motor vehicle including at least two braking devices each having a brake actuator, wherein each of the brake actuators has an electric actuating motor, and wherein the braking devices are connected to a central control unit which is designed for connecting to at least one input device, wherein the method comprises:
entering a brake command by way of at least one input device into the central control unit which actuates the brake actuators using control signals;
wherein the central control unit sends control signals to at least two wheel brake control units which are in each case assigned to a braking device and in each case actuate a brake actuator of the respective braking device.

26. The method as claimed in claim 25, wherein actual signals from a wheel sensor of the respective braking device are transmitted to each of the wheel brake control units.

27. The method as claimed in claim 26, wherein the braking device has an actuating device which is able to be coupled to an actuating motor and comprises a first actuating drive and a second actuating drive coupled in series thereto, and which acts on a brake part that in the direction of an axis can be brought into braking engagement with a counter-braking part, wherein the first actuating drive has a rotationally drivable first drive wheel to which a first drive torque can be applied for activation, and the second actuating drive has a rotationally drivable second drive wheel which is coaxial with the first drive wheel and to which a second drive torque can be applied for activation, wherein a clutch device is disposed between the first drive wheel and the second drive wheel.

28. The method as claimed in claim 27, wherein the coupling device is configured as a friction clutch and has a predefinable coupling torque which when exceeded causes the first drive wheel to slip relative to the second drive wheel, wherein, for activation of the first actuating drive, the first drive wheel and the second drive wheel are driven synchronously so that the second actuating drive remains non-activated, and for activation of the second actuating drive, the second drive wheel is driven and the first drive wheel is stopped relative thereto, so that the friction clutch slips and the first actuating drive remains non-activated.
